(19) United States
(12) Patent Application Publication
(10) Pub. No.: US 2026/0248317 A1
(43) Pub. Date: Aug. 27, 2026

(54) Milk Powder Brewing Machine

(71) Applicant: heyaxa products INC, ANAHEIM, CA (US)

(72) Inventor: Lei XIA, ANAHEIM, CA (US)

(73) Assignee: heyaxa products INC, ANAHEIM, CA (US)

(21) Appl. No.: 19/060,922

(22) Filed: Feb. 24, 2025

(51) Int. Cl. A47J 31/40; A47J 31/44

(52) U.S. Cl. CPC A47J 31/401; A47J 31/4403

(57) ABSTRACT

The present disclosure provides a milk powder brewing machine, which comprises a milk powder brewing machine body; and a feeding bottle fixing device which is rotatably arranged on the milk powder brewing machine body and has a plurality of working positions to provide a plurality of different working heights; a driving mechanism arranged in the milk powder brewing machine body and used for driving the feeding bottle fixing device to rotate; and a feeding bottle fixing cylinder used for installing and placing a feeding bottle, wherein the feeding bottle can be selectively and flexibly installed in the fixing cylinder as required and rotates along with the feeding bottle fixing device; wherein, the feeding bottle fixing cylinder can be selectively installed at a selected position among a plurality of working positions on the feeding bottle fixing device to adjust the distance between the feeding bottle fixing cylinder and the nozzle module.

### TECHNICAL FIELD

The present disclosure relates to the technical field of milk powder brewing devices, particularly to a milk powder brewing machine.

### BACKGROUND

For families with infants, milk powder brewing is a very normal but troublesome thing. Especially for babies, they may need to drink milk three or four times a night. Parents are often in a daze when they get up in the middle of the night to brew milk powder, which is very inconvenient.

There are also some milk powder brewing machines in the prior art, for example US patents with publication numbers of US20210145205A1, US20220338667A1 and US20230301458A1, and U.S. Pat. No. 11,503,943, all of which propose machines for brewing milk powder. However, the height between the water outlet of the above-mentioned automatic milk brewing machine and the feeding bottle placement position is fixed. There are various specifications of feeding bottles in the market. When using smaller bottles for brewing, the distance between the mouth of the feeding bottle and the water outlet of the milk brewing machine is often too large, which causes the water and milk powder to easily splash out of the feeding bottle due to the impact during brewing, which not only causes waste of ingredients, but also may bring inconvenience to the cleaning work of users.

Therefore, in order to solve the above problems, a milk powder brewing machine is needed, which can be adapted for most specifications of feeding bottles and can avoid splashing when brewing milk powder.

### SUMMARY

The present disclosure provides a milk powder brewing machine, which includes a milk powder brewing machine body; a bottle fixing device, which includes an outer cylinder rotatably arranged on the milk powder brewing machine body and a feeding bottle fixing cylinder for placing a feeding bottle, wherein the feeding bottle fixing cylinder can be installed on the outer cylinder and rotates with the outer cylinder, the outer cylinder is provided with a plurality of working positions for providing different working heights, and the feeding bottle fixing cylinder can be selectively installed in one of the working positions on the feeding bottle fixing device; a driving mechanism arranged in the milk powder brewing machine body and used for driving the feeding bottle fixing device to rotate; and a nozzle module, which includes a water outlet nozzle and a powder outlet nozzle, wherein the water outlet nozzle and the powder outlet nozzle are both connected to the milk powder brewing machine body and are arranged above the feeding bottle fixing device; the water outlet nozzle is used for distributing liquid to the feeding bottle on the feeding bottle fixing cylinder, and the powder outlet nozzle is used for distributing powder to the feeding bottle on the feeding bottle fixing cylinder;
a heat preservation module is arranged in the feeding bottle fixing device, and the heat preservation module is used for heating and preserving heat of the feeding bottle in the feeding bottle fixing cylinder;
a plurality of elastic elements are arranged on the inner wall of the feeding bottle fixing cylinder, the elastic element includes an elastic element arranged on the inner wall of the feeding bottle fixing cylinder, and the elastic element includes a connecting section and an elastic section, wherein the connecting section is connected with an inner wall of the feeding bottle fixing cylinder, the elastic section is formed on the connecting section and protrudes and extends to the interior of the feeding bottle fixing cylinder; and the feeding bottle enters the feeding bottle fixing cylinder to compress the elastic elements, the elastic sections are elastically compressed by a force to generate an elastic force, and the elastic deformation of the elastic elements generates a clamping force for the feeding bottle to clamp the feeding bottle.

### BRIEF DESCRIPTION OF DRAWINGS

The drawings, which constitute a part of this application, are used to provide a further understanding of the present disclosure. The illustrative embodiments of the present disclosure and the descriptions thereof are used to explain the present disclosure, and do not constitute undue limitations on the present disclosure. In the drawings:

FIG. 1 shows a schematic structural diagram of an embodiment of a milk powder brewing machine according to the present disclosure;

FIG. 2 shows a schematic structural diagram of a bottle fixing device and a feeding bottle fixing cylinder of the milk powder brewing machine in FIG. 1;

FIG. 3 shows the structure of the feeding bottle fixing device and the feeding bottle fixing cylinder in FIG. 2 from another angle;

FIG. 4 shows an explosion schematic diagram of the structure of the feeding bottle fixing device in FIG. 2;

FIG. 5 shows an explosion schematic diagram of the feeding bottle fixing device and the feeding bottle fixing cylinder structure in FIG. 2;

FIG. 6 shows the structural schematic diagram of the feeding bottle fixing device in FIG. 2;

FIG. 7 shows a schematic structural view of the feeding bottle fixing cylinder in FIG. 2.

The above drawings include the following reference signs:

Milk powder brewing machine body (1); Feeding bottle fixing device (2); Water outlet nozzle (3); Powder outlet nozzle (4); Feeding bottle fixing cylinder (11); Outer cylinder (12); Door closure (13); Rotating disc (14); Elastic element (111); Clamping block (112); Connecting section (113); Elastic section (114); Fixing groove (121); Mounting groove (122); Wall opening (123); Strip (124); Groove (125); Slot (131); First row (A); Second row (B).

### DESCRIPTION OF EMBODIMENTS

The technical solution in the embodiment of the present disclosure will be clearly and completely described below with reference to the drawings. Obviously, the described embodiment is part of, rather than all of the embodiments of the present disclosure. The following description of at least one exemplary embodiment is illustrative in nature and is in no way intended to limit the present disclosure, its application or uses. Based on the embodiments in the present disclosure, all other embodiments obtained by those skilled in the art without creative work belong to the scope of protection of the present disclosure.

It should be noted that the terminology used here is only for describing specific embodiments, and is not intended to limit exemplary embodiments according to the present application. As used herein, the singular form is also intended to include the plural form unless the context clearly indicates otherwise. Furthermore, it should be appreciated that when the terms “comprising” and/or “including” are used in this specification, they specify the presence of features, steps, operations, devices, components and/or combinations thereof.

Unless otherwise specified, the relative arrangement of components and steps, numerical expressions and numerical values set forth in these embodiments do not limit the scope of the present disclosure. At the same time, it should be appreciated that for the convenience of description, the dimensions of various parts shown in the drawings are not drawn according to the actual scale relationship. Techniques, methods and equipment known to those skilled in the art may not be discussed in detail, but in appropriate cases, they should be regarded as part of the authorization specification. In all the examples shown and discussed herein, any specific values should be interpreted as illustrative, and not as limiting. Therefore, other examples of exemplary embodiments may have different values. It should be noted that similar numbers and letters indicate similar items in the following drawings, therefore once an item is defined in one drawing, it does not need to be further discussed in subsequent drawings.

The distance between the feeding bottle and the water outlet is fixed, which cannot adapt to different specifications of the feeding bottle. When the feeding bottle with a small size is used, the distance between the feeding bottle mouth and the water outlet is too large, which will easily cause water and milk powder to splash out of the feeding bottle during the brewing process, resulting in waste of food ingredients and inconvenience in cleaning.

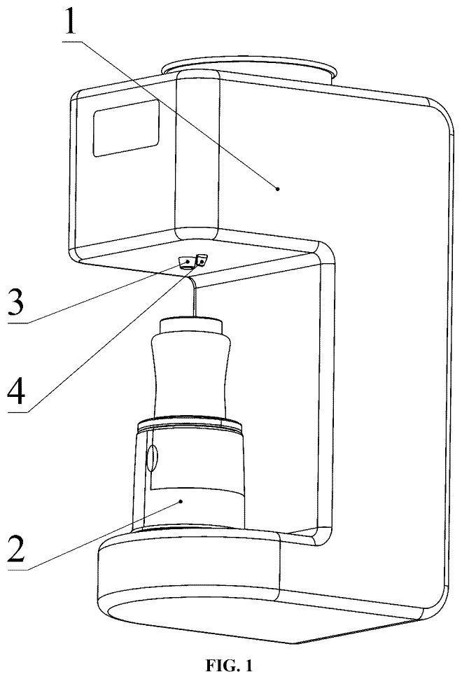

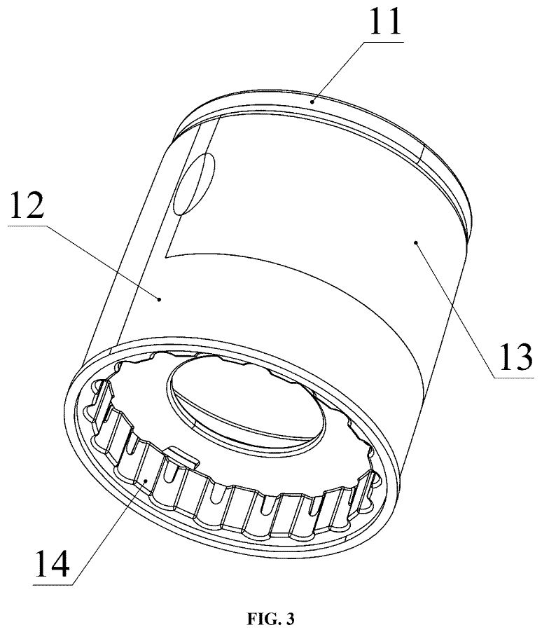

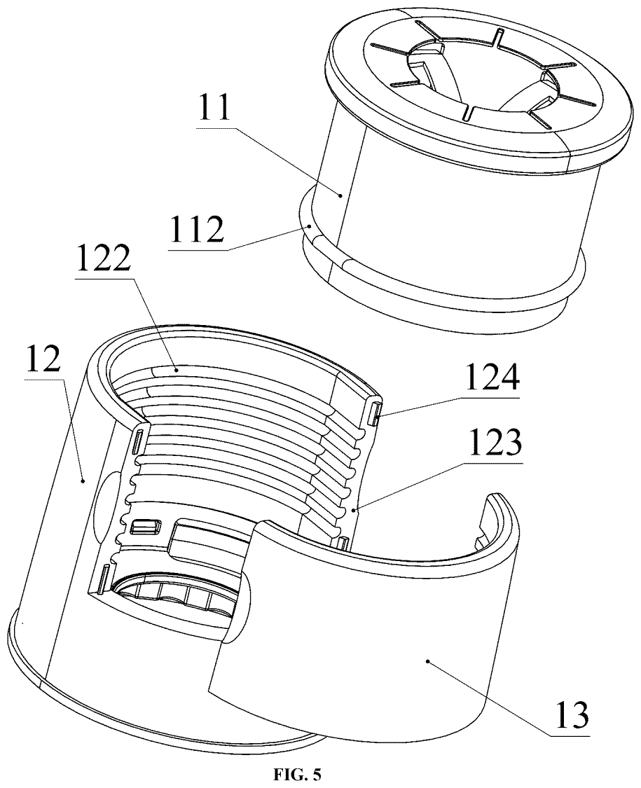

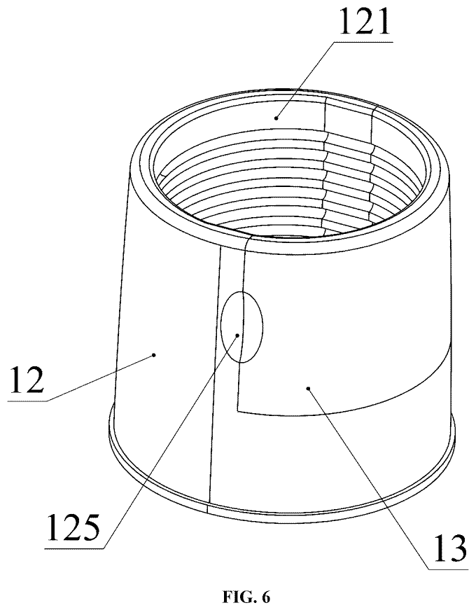

The present disclosure aims to overcome the shortcomings of the prior art, as shown in FIGS. 1-7, by providing a milk powder brewing machine capable of adjusting the height of a feeding bottle, which includes a milk powder brewing machine body 1; a feeding bottle fixing device, which includes an outer cylinder rotatably arranged on the milk powder brewing machine body and a feeding bottle fixing cylinder for placing the feeding bottle, wherein the feeding bottle fixing cylinder can be installed on the outer cylinder and rotates with the outer cylinder; a driving mechanism arranged in the milk powder brewing machine body 1 and used for driving the feeding bottle fixing device 2 to rotate; a nozzle module; and a feeding bottle fixing cylinder 11, which is used for installing and placing the feeding bottle, and is selectively installed to the feeding bottle fixing device 2 and rotates along with the feeding bottle fixing device 2. The outer cylinder 12 is provided with a plurality of working positions for providing different working heights, and the feeding bottle fixing cylinder 11 can be selectively installed in one of the working positions on the feeding bottle fixing device 2 to adjust the distance between the feeding bottle fixing cylinder 2 and the nozzle module.

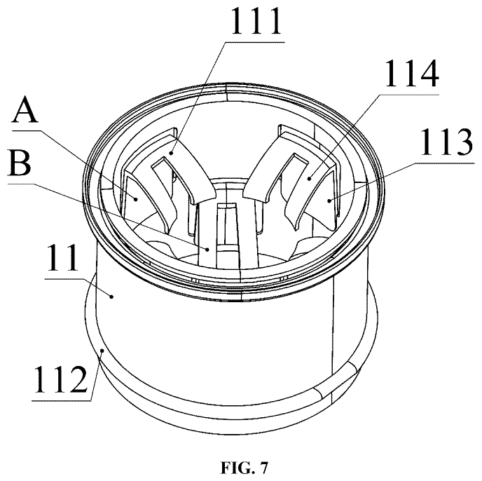

As shown in FIG. 7, the inner wall of the feeding bottle fixing cylinder 11 is provided with a plurality of elastic elements. In this embodiment, the elastic elements are embodied as elastic elements 111 arranged on the inner wall of the feeding bottle fixing cylinder 11. The elastic elements 111 include a connecting section 113 and an elastic section 114. The connecting section 113 is connected with the inner wall of the feeding bottle fixing cylinder 11, and the elastic section 114 is formed on the connecting section 113 and protrudes and extends to the interior of the feeding bottle fixing cylinder 11. The feeding bottle enters the feeding bottle fixing cylinder 11 to compress the elastic element, the elastic section 114 is elastically compressed to generate an elastic force, and the elastic deformation of the elastic element generates a clamping force for the feeding bottle to clamp the feeding bottle. The elastic element 111 can be realized in the form of silica gel gasket, which can provide a uniform clamping force for the feeding bottle by the softness and elasticity of silica gel to avoid damaging the surface of the feeding bottle at the same time, or it can be realized in the form of rubber block, which can provide a uniform clamping force for the feeding bottle by the softness and elasticity of the rubber block. In addition, the elastic element can also be a plurality of spring clips arranged on the inner wall of the feeding bottle fixing cylinder 11, and the feeding bottle is clamped by the elastic force of the spring to ensure that the feeding bottle is stable in the brewing process; or magnetic materials are arranged on the inner wall of the feeding bottle fixing cylinder 11 and the outer wall of the feeding bottle, and the stable clamping of the feeding bottle is realized by a magnetic force.

The elastic elements are arranged in at least two rows, including a first row A and a second row B arranged below the first row A. The elastic elements of the first row A and the second row B are arranged circumferentially along the inner wall of the feeding bottle fixing cylinder 11 respectively, and the elastic elements of the first row A and the second row B are staggered with each other.

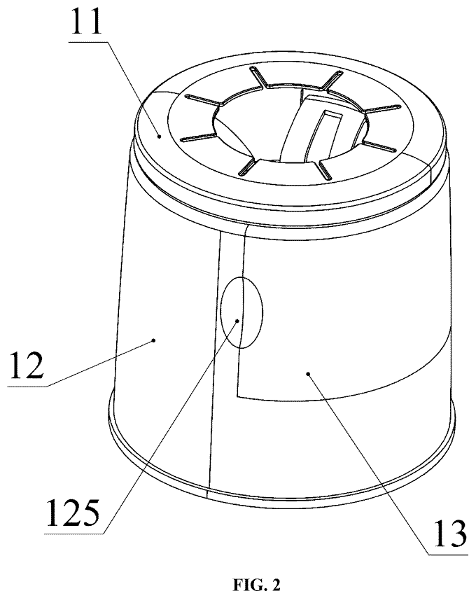

As shown in FIG. 2-FIG. 6, the feeding bottle fixing device 2 is provided with a fixing groove 121 capable of partially accommodating the feeding bottle fixing cylinder 11, the top of the feeding bottle fixing device 2 is provided with a notch communicating with the fixing groove 121, and a plurality of mounting grooves 122 at different height positions are formed on the inner wall of the fixing groove 121. These mounting grooves 122 are arranged at intervals along the height direction to form a plurality of working positions. The mounting grooves 122 are configured to be formed on the inner wall of the fixing groove 121, and extends along the circumferential direction of the feeding bottle fixing device 2 to form a ring shape. A clamping block 112 matched with the mounting groove 122 is formed on the outer periphery of the feeding bottle fixing cylinder 11. In this embodiment, the clamping block 112 is implemented as an annular flange formed on the outer periphery of the feeding bottle fixing cylinder 11.

The inner wall of the fixing groove 121 can be provided with a passage communicating with each mounting groove 122. The clamping block 112 is designed as a sliding pin which can slide along the passage. The sliding pin slides into the mounting groove 122 along with the rotation of the feeding bottle fixing cylinder 11 to complete the height selection, which is equivalent to setting a sliding track on the inner wall of the fixing groove 121. The feeding bottle fixing cylinder 11 can slide along the track and be fixed at different height positions, which is convenient for adjustment. In some embodiments, a plurality of buckles can be arranged on the inner wall of the fixing groove 121, and the periphery of the feeding bottle fixing cylinder 11 is provided with corresponding clamping grooves, so that the height adjustment can be realized through the fitting of the buckles and the clamping grooves; or magnetic materials are arranged on the inner wall of the fixing groove 121 and the periphery of the feeding bottle fixing cylinder 11, and the fixing and height adjustment of the feeding bottle fixing cylinder 11 are realized by magnetic adsorption. The inner wall of the outer cylinder 12 is symmetrically provided with a plurality of clamping grooves along the vertical direction, and the outer wall of the feeding bottle fixing cylinder 11 is symmetrically provided with clamping tenons. The clamping tenons are clamped on the clamping grooves by counterclockwise rotation, and the height of the feeding bottle fixing cylinder 11 is adjusted by clamping the clamping grooves at different heights, so that the rotating mechanism can be lifted, thereby supporting the lifting of the feeding bottle.

The feeding bottle fixing device 2 can be designed integrally with or separately from the milk powder brewing machine body 1, that is, the feeding bottle fixing device 2 can be designed to be detachable or non-detachable.

As shown in FIG. 2-FIG. 5, the outer cylinder 12 is detachably connected with a door closure 13, the peripheral wall of the outer cylinder 12 is provided with a wall opening 123 through which the feeding bottle fixing cylinder 11 can pass, and the door closure 13 can be detachably installed to the wall opening 123 of the outer cylinder 12. The door closure 13 is arc-shaped, and at least one end of the arc is provided with a strip, and the opening of the outer cylinder 12 is provided with a slot 131 for inserting the strip 124. In addition, a rotary locking mechanism can be arranged between the door closure 13 and the outer cylinder 12. By arranging the rotary locking mechanism at the openings of the door closure 13 and the outer cylinder 12, the door closure 13 can be quickly locked and disassembled, which increases the convenience of operation; alternatively, magnetic materials are arranged at the openings of the door closure 13 and the outer cylinder 12, and the door closure 13 can be fixed and detached by magnetic adsorption, so that the operation is simple and stable. The outer cylinder 12 is provided with a groove 125 for facilitating the opening the door closure 13.

With this design, the milk powder brewing machine of the present disclosure can adapt to different specifications of feeding bottles, avoid the splashing problem caused by height mismatch, and improve the efficiency and convenience of milk powder brewing. At the same time, users can flexibly adjust the height of the feeding bottle according to their needs, so as to ensure that each time of brewing can be carried out smoothly and reduce the waste of ingredients and the burden of cleaning.

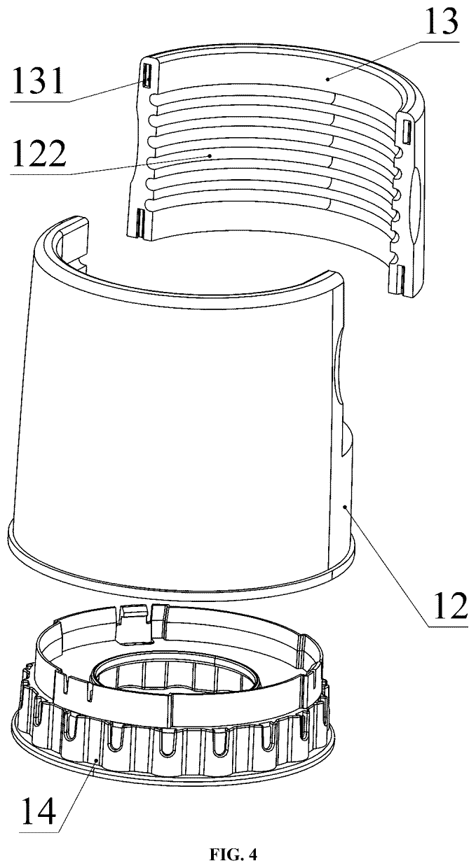

As shown in FIG. 4, the feeding bottle fixing device 2 further includes a rotating disc 14, which is rotatably connected with the milk powder brewing machine body 1 and driven by a driving mechanism to rotate, and the outer cylinder 12 is arranged on the rotating disc 14 and rotates with the rotating disc 14.

As for the driving mechanism to drive the rotating disc 14 to rotate, it belongs to the conventional technical means in the field of milk powder brewing machine, which mainly includes setting a driving motor in the milk powder brewing machine. The transmission between the driving motor and the rotating disc 14 is not limited to gears, worm gears or belts, which therefore will not be described in this embodiment.

In some embodiments, the milk powder brewing machine body 1 or the feeding bottle fixing device 2 can also be provided with an automatic lifting mechanism, which is used for controlling the feeding bottle fixing cylinder 11 to switch between the plurality of working positions in the feeding bottle fixing device 2, so as to adjust the working height of the feeding bottle fixing cylinder 11, thereby adjusting the distance between the feeding bottle fixing cylinder 11 and the nozzle module. The specific embodiment can be that a telescopic mechanism such as an electric push rod, a telescopic screw or a telescopic hinge frame is arranged on the rotating disc 14. Its movable end is connected to the feeding bottle fixing cylinder 11 to drive the feeding bottle fixing cylinder 11 to expand and contract, so as to control the feeding bottle fixing cylinder 11 to switch between the plurality of working positions in the feeding bottle fixing device 2. Further, in the embodiment of the working position in the form of the mounting groove 122, the clamping block 112 on the feeding bottle fixing cylinder 11 can be designed to be more easily elastically deformed, so that when the automatic lifting mechanism pushes the feeding bottle fixing cylinder 11, the clamping block 112 is more easily compressed to cause the clamping block 112 to be separated from the mounting groove 122, and then to pop up and locate when it reaches the next mounting groove 122, which facilitates the switching of the feeding bottle fixing cylinder 11 between multiple working positions.

A heat preservation module is arranged in the feeding bottle fixing device 2, and the heat preservation module is used for temperature control and heat preservation of the feeding bottle in the feeding bottle fixing cylinder 11. The heat preservation module can be implemented in many ways, such as installing an electric heating piece in the feeding bottle fixing device 2, heating the feeding bottle by electric heating to ensure that the feeding bottle is always kept at an appropriate temperature, equipping a constant temperature controller to monitor and adjust the temperature of the feeding bottle in real time, and using efficient heat preservation materials on the inner wall of the feeding bottle fixing device 2 to reduce heat loss and prolong the heat preservation time of the feeding bottle. Through these various heat preservation methods, the liquid in the feeding bottle is always kept at an appropriate temperature, which improves the convenience of use and users.

However, the milk powder brewing machine in the prior art has the problems of uneven mixing of milk and caking of milk powder left in the feeding bottle and the mixing bin, which causes it impossible to accurately control the amount and quantity of milk powder. Too much or too little milk powder will affect the digestion and nutrition of infants.

The milk powder brewing machine body 1 further includes a liquid loop installed in the milk powder brewing machine body 1, including a water storage chamber, a liquid conduit and a liquid distribution mechanism. The liquid distribution mechanism discharges warm water from the water storage chamber to the outside through THE water outlet nozzle 3.

The milk powder brewing machine body 1 further includes a powder loop installed in the milk powder brewing machine body 1, including a powder storage chamber, a powder conduit and a powder distribution mechanism. The powder distribution mechanism discharges powder from the powder storage chamber to the outside through the powder outlet nozzle 4.

From the above description, it can be seen that the above embodiment of the present disclosure has achieved the following technical effects: by providing a milk powder brewing machine, the milk powder brewing machine is provided with a milk powder nozzle and an independent water spray nozzle for spraying milk powder and warm water into a lower feeding bottle so as to be mixed in the feeding bottle; and the milk powder brewing machine further includes a rotating mechanism which is rotatably installed on an automatic milk brewing machine and is located below the milk powder nozzle and the water spray nozzle, and the rotating mechanism includes an outer cylinder 12, and a feeding bottle fixing cylinder 11 clamped in an outer cylinder 12, wherein the bottom of the outer cylinder 12 is connected with a rotating disc 14 installed onto the milk powder brewing machine, silica gel is arranged on the inner wall of the feeding bottle fixing cylinder 11, and the silica gel and the feeding bottle are in close contact, so that the feeding bottle can rotate with the feeding bottle fixing cylinder, allowing the milk powder and water to be fully blended, thereby eliminating bubbles, and preventing milk lumps.

In the description of the present disclosure, it should be appreciated that the orientation or positional relationship indicated by orientation words such as “front, back, upper, lower, left, right”, “lateral, vertical, horizontal” and “top, bottom” are usually based on the orientation or positional relationship shown in the attached drawings, just for the convenience of describing the present disclosure and simplifying the description. Unless otherwise stated, these orientation words do not indicate or imply that the device or element referred to must have a specific orientation or be constructed and operated in a specific orientation, therefore they cannot be construed as limiting the scope of protection of the present disclosure. The orientation words “inside and outside” refer to the inside and outside relative to the outline of each component itself.

For the convenience of description, spatially relative terms such as “above”, “on”, “on the upper surface of” and “upper” can be used here to describe the spatial positional relationship between a device or feature as shown in the drawings and other devices or features. It should be appreciated that spatially relative terms are intended to encompass different orientations in use or operation in addition to the orientation of the device depicted in the drawings. For example, if the devices in the drawings are inverted, devices described as “above” or “on” other devices or structures will be positioned as “below” or “under” other devices or structures. Thus, the exemplary term “above” can include both orientation of “above” and “below”. The device can also be positioned in other different ways (rotated by 90 degrees or in other orientations), and the spatial relative description used here is explained accordingly.

In addition, it should be noted that the words “first” and “second” are used to define parts for the convenience of distinguishing the corresponding parts. Unless otherwise stated, the above words have no special meaning, and thus they cannot be construed as limiting the protection scope of the present disclosure.

What has been described above is only the preferred embodiment of the present disclosure, and it is not intended to limit the present disclosure. For those skilled in the art, the present disclosure may have various modifications and changes. Any modification, equivalent substitution, improvement and the like made within the spirit and principle of the present disclosure shall fall into the protection scope of the present disclosure.

What is claimed is:

1. A milk powder brewing machine, comprising:
a milk powder brewing machine body;
a feeding bottle fixing device, comprising an outer cylinder rotatably arranged on the milk powder brewing machine body and a feeding bottle fixing cylinder for placing a feeding bottle, wherein the feeding bottle fixing cylinder can be installed on the outer cylinder and rotates with the outer cylinder; and
a nozzle module, comprising at least one water outlet nozzle and/or at least one powder outlet nozzle, wherein the water outlet nozzle and the powder outlet nozzle are both connected to the milk powder brewing machine body and are arranged above the feeding bottle fixing device, the water outlet nozzle is configured for distributing liquid to the feeding bottle on the feeding bottle fixing cylinder, and the powder outlet nozzle is configured for distributing powder to the feeding bottle on the feeding bottle fixing cylinder; and
wherein the outer cylinder is provided with a plurality of working positions for providing different working heights, and the feeding bottle fixing cylinder can be selectively installed in one of the working positions on the feeding bottle fixing device to adjust a distance between the feeding bottle fixing cylinder and the nozzle module.

2. The milk powder brewing machine according to claim 1, wherein the feeding bottle fixing device is provided with a plurality of mounting grooves at different height positions, and the mounting grooves are arranged at intervals to form the working positions.

3. The milk powder brewing machine according to claim 2, wherein a fixing groove capable of partially accommodating the feeding bottle fixing cylinder is formed in the feeding bottle fixing device, a notch communicated with the fixing groove is formed at a top of the feeding bottle fixing device, and the mounting grooves are formed on an inner wall of the fixing groove.

4. The milk powder brewing machine according to claim 3, wherein the mounting grooves are configured to be formed on the inner wall of the fixing groove and extend in a circumferential direction of the feeding bottle fixing device to form a ring shape, and a clamping block matched with the mounting grooves is formed on an outer periphery of the feeding bottle fixing cylinder.

5. The milk powder brewing machine according to claim 3, wherein the outer cylinder is detachably connected with a door closure, a peripheral wall of the outer cylinder is provided with a wall opening for the feeding bottle fixing cylinder to pass through, and the feeding bottle fixing cylinder can be installed in the outer cylinder through the opening; and the door closure is matched with a shape of the wall opening of the peripheral wall of the outer cylinder, and the door closure is detachably installed to the wall opening of the outer cylinder.

6. The milk powder brewing machine according to claim 5, wherein the door closure is arc-shaped, at least one end of the arc-shaped door closure is provided with a strip, and an opening of the outer cylinder is provided with a slot for inserting the strip.

7. The milk powder brewing machine according to claim 5, wherein the feeding bottle fixing device further comprises a rotating disc, which is rotatably connected with the milk powder brewing machine body and driven by a driving mechanism to rotate, and the outer cylinder is arranged on the rotating disc and rotates with the rotating disc.

8. The milk powder brewing machine according to claim 1, wherein a heat preservation module is arranged in the feeding bottle fixing device, and the heat preservation module is configured for temperature control and heat preservation of the feeding bottle in the feeding bottle fixing cylinder.

9. The milk powder brewing machine according to claim 1, wherein a clamping body is arranged on the inner wall of the feeding bottle fixing cylinder, and the clamping body provides a clamping force for the feeding bottle in the feeding bottle fixing cylinder to clamp the feeding bottle.

10. The milk powder brewing machine according to claim 9, wherein the clamping body comprises a plurality of elastic elements arranged on the inner wall of the feeding bottle fixing cylinder, the feeding bottle enters the feeding bottle fixing cylinder to compress the elastic elements, and the elastic elements elastically deform to generate a clamping force for the feeding bottle to clamp the feeding bottle.

11. The milk powder brewing machine according to claim 10, wherein the elastic element comprises an elastic element arranged on the inner wall of the feeding bottle fixing cylinder, and the elastic element comprises a connecting section and an elastic section, wherein the connecting section is connected with an inner wall of the feeding bottle fixing cylinder, the elastic section is formed on the connecting section and protrudes and extends to an interior of the feeding bottle fixing cylinder, and the elastic section is elastically compressed by a force to generate an elastic force.

12. The milk powder brewing machine according to claim 10, wherein elastic elements are arranged in at least two rows, including a first row and a second row arranged below the first row, wherein the elastic elements in the first row and the second row are arranged circumferentially along the inner wall of the feeding bottle fixing cylinder, respectively, and the elastic elements in the first row and the second row are staggered with each other.

13. A milk powder brewing machine, comprising:
a milk powder brewing machine body;
a feeding bottle fixing device, comprising an outer cylinder rotatably arranged on the milk powder brewing machine body and a feeding bottle fixing cylinder for placing a feeding bottle, wherein the feeding bottle fixing cylinder can be installed on the outer cylinder and rotates with the outer cylinder, the outer cylinder is provided with a plurality of working positions for providing different working heights, and the feeding bottle fixing cylinder can be selectively installed in one of the plurality of working positions on the feeding bottle fixing device;
elastic elements arranged on the feeding bottle fixing cylinder and configured for generating a clamping force on the feeding bottle when the feeding bottle enters the feeding bottle fixing cylinder;
a nozzle module, comprising at least one water outlet nozzle and/or at least one powder outlet nozzle, wherein the nozzle module is connected to the milk powder brewing machine body and is arranged above the feeding bottle fixing device, the water outlet nozzle is configured for distributing liquid to the feeding bottle in the feeding bottle fixing cylinder, and the powder outlet nozzle is configured for distributing powder to the feeding bottle in the feeding bottle fixing cylinder; and
an automatic lifting mechanism configured for controlling the feeding bottle fixing cylinder to switch between the plurality of working positions in the feeding bottle fixing device, so as to adjust a working height of the feeding bottle fixing cylinder, thereby adjusting a distance between the feeding bottle fixing cylinder and the nozzle module.

14. The milk powder brewing machine according to claim 13, wherein a fixing groove capable of partially accommodating the feeding bottle fixing cylinder is formed in the feeding bottle fixing device, and a notch communicated with the fixing groove is formed at a top of the feeding bottle fixing device; and a plurality of mounting grooves at different height positions are formed on an inner wall of the fixing groove, the mounting grooves form the working positions; and the mounting grooves are configured to be formed on the inner wall of the fixing groove and extend along a circumferential direction of the feeding bottle fixing device to form a ring shape, and a clamping block matched with the mounting grooves is formed on an outer periphery of the feeding bottle fixing cylinder.

15. The milk powder brewing machine according to claim 14, wherein a door closure is detachably connected to the outer cylinder, and a peripheral wall of the outer cylinder is provided with a wall opening for the feeding bottle fixing cylinder to pass through; and the feeding bottle fixing cylinder can be installed into the outer cylinder through the opening, at least one end of the arc-shaped door closure is provided with a strip, and the opening of the outer cylinder is provided with a slot for inserting the strip.

16. The milk powder brewing machine according to claim 13, wherein the elastic elements comprise a connecting section and an elastic section, wherein the connecting section is connected with an inner wall of the feeding bottle fixing cylinder, the elastic section is formed on the connecting section and protrudes and extends to the interior of the feeding bottle fixing cylinder, and the elastic section is elastically compressed by a force to generate an elastic force; and the elastic elements are arranged in at least two rows, including a first row and a second row arranged below the first row, the elastic elements in the first row and the second row are arranged circumferentially along the inner wall of the feeding bottle fixing cylinder, respectively, and the elastic elements in the first row and the second row are staggered with each other.

17. The milk powder brewing machine according to claim 13, wherein a heat preservation module is arranged in the feeding bottle fixing device, and the heat preservation module is configured for temperature control and heat preservation of the feeding bottle in the feeding bottle fixing cylinder.

18. A milk powder brewing machine, comprising:
a milk powder brewing machine body;
a feeding bottle fixing device, comprising an outer cylinder rotatably arranged on the milk powder brewing machine body and a feeding bottle fixing cylinder for placing the feeding bottle, wherein the feeding bottle fixing cylinder can be installed on the outer cylinder and rotates with the outer cylinder, the outer cylinder is provided with a plurality of working positions for providing different working heights, and the feeding bottle fixing cylinder can be selectively installed in one of the plurality of working positions on the feeding bottle fixing device;
a nozzle module, comprising at least one water outlet nozzle and/or at least one powder outlet nozzle, wherein the nozzle module is connected to the milk powder brewing machine body and is arranged above the feeding bottle fixing device, the water outlet nozzle is configured for distributing liquid to the feeding bottle in the feeding bottle fixing cylinder, and the powder outlet nozzle is configured for distributing powder to the feeding bottle in the feeding bottle fixing cylinder;
an automatic lifting mechanism configured for control that feeding bottle fixing cylinder to switch between the plurality of working positions in the feeding bottle fix device so as to adjust a working height of the feeding bottle fixing cylinder, thereby adjusting a distance between the feeding bottle fixing cylinder and the nozzle module; and
a heat preservation module arranged in the feeding bottle fixing device and configured for temperature control and heat preservation of the feeding bottle in the feeding bottle fixing cylinder.

19. The milk powder brewing machine according to claim 18, wherein a fixing groove capable of partially accommodating the feeding bottle fixing cylinder is formed in the feeding bottle fixing device, and a notch communicated with the fixing groove is formed at a top of the feeding bottle fixing device; and a plurality of mounting grooves at different height positions are formed on an inner wall of the fixing groove, the mounting grooves form the working positions, and the mounting grooves are configured to be formed on the inner wall of the fixing groove and extend along a circumferential direction of the feeding bottle fixing device to form a ring shape; and a clamping block matched with the mounting grooves is formed on the periphery of the feeding bottle fixing cylinder, a door closure is detachably connected to the outer cylinder, and a peripheral wall of the outer cylinder is provided with a wall opening for the feeding bottle fixing cylinder to pass through; and the feeding bottle fixing cylinder can be installed in the outer cylinder through the opening, a strip is arranged on at least one end of the arc-shaped door closure, and a slot for inserting the strip is formed on the opening of the outer cylinder.

20. The milk powder brewing machine according to claim 18, wherein elastic elements are arranged on the feeding bottle fixing cylinder, the elastic elements comprise a connecting section and an elastic section, wherein the connecting section is connected with an inner wall of the feeding bottle fixing cylinder, the elastic section protrudes from the connecting section and extends to an interior of the feeding bottle fixing cylinder, and the elastic section is elastically compresses by a force to generate an elastic force; and the elastic elements are arranged in at least two rows, including a first row and a second row arranged below the first row, the elastic elements in the first and second rows are arranged circumferentially along the inner wall of the feeding bottle fixing cylinder, respectively, and the elastic elements in the first row and the second row are staggered with each other.
